(19) United States
(12) Patent Application Publication
(10) Pub. No.: US 2012/0306777 A1
(43) Pub. Date: Dec. 6, 2012

(54) FLEXIBLE TOUCH SCREEN PANEL

(75) Inventors: Sung-Ku Kang, Yongin-city (KR); Tae-Hyeog Jung, Yongin-city (KR); Sun-Haeng Cho, Yongin-city (KR)

(73) Assignee: SAMSUNG MOBILE DISPLAY CO., LTD., Yongin-city (KR)

(21) Appl. No.: 13/240,917

(22) Filed: Sep. 22, 2011

(30) Foreign Application Priority Data
Jun. 1, 2011 (KR) 10-2011-0052731

(51) Int. Cl. G06F 3/041

(52) U.S. Cl. 345/173

(57) ABSTRACT

A flexible touch screen panel is disclosed. The flexible touch screen panel has sensing patterns formed on a thin film substrate as touch sensors, and a phase difference compensation layer formed on the sensing patterns to compensate phase difference generated by characteristics of the thin film substrate, in order to minimize deterioration of image quality. The flexible touch screen panel includes a thin film substrate having an active area and a non-active area positioned outside the active area, sensing patterns formed on the active area and sensing lines formed on the non-active area and connected to the sensing patterns. The thin film substrate is made of polyimide.

### CROSS-REFERENCE TO RELATED APPLICATIONS

This application claims priority to and the benefit of Korean Patent Application No. 10-2011-0052731, filed on Jun. 1, 2011, in the Korean Intellectual Property Office, the entire content of which is incorporated herein by reference.

### BACKGROUND

1. Field

The present disclosure relates to a touch screen panel, and more particularly to a flexible touch screen panel and a method of manufacturing the same.

2. Description of the Related Technology

A touch screen panel is an input device enabling selection of commands displayed on a screen, such as an image display device, with a finger or a tool being used to input user commands.

To this end, a touch screen panel is provided on a front face of an image display device, and converts a position touched by a finger or a tool into an electric signal. By doing so, a command selected from the touch position is received as an input signal.

The touch screen panel may be a substitute for a separate input device such as a keyboard or a mouse connected to an image display device, and due to this convenience, it has an expanding number of uses.

There are various touch screen panels such as for example a resistive touch screen panel, a light sensitive touch screen panel, and a capacitive touch screen panel. A capacitive touch screen panel senses a change of electrostatic capacity formed by conductive sensing patterns in association with other ambient sensing patterns or a ground electrode when a finger or an object touches the touch screen panel.

In general, the touch screen panel is attached to an outer side of a flat display device such as a liquid crystal display device, an organic light emitting display device, and the like, for an end product. Therefore, the touch screen panel must usually be thin and possess high transparency.

Flexible flat display devices have been developed recently, and the touch screen panel may be attached to a flexible flat display device, thereby requiring the touch screen panel to also be flexible.

However, since a capacitive touch screen panel needs a thin film membrane process, and a pattern forming process for sensing patterns of forming a touch sensor, the capacitive touch screen panel needs high heat resistance and high chemical resistance.

Due to these needs for high resistance, current capacitive touch screen panels have their sensing patterns formed on a glass substrate. However, since the glass substrate must be thicker than a predetermined thickness to be transferred during the processes, the glass substrate is not well suited for the qualities of thinness and flexibility.

### SUMMARY OF CERTAIN INVENTIVE ASPECTS

Disclosed embodiments provide a flexible touch screen panel in which sensing patterns are formed on a thin film substrate as touch sensors and in which a phase difference compensation layer is formed on the sensing patterns to compensate a phase difference generated by characteristics of the thin film substrate, to minimize deterioration of image quality.

In order to achieve the foregoing and/or other aspects, in one embodiment, there is provided a flexible touch screen panel including: a thin film substrate including an active area and a non-active area, where the non-active area is positioned outside the active area, a plurality of sensing patterns formed on the active area, and sensing lines formed on the non-active area and connected to the sensing patterns, where the thin film substrate is made of polyimide.

The thin film substrate may have a thickness from about 0.005 mm to about 0.05 mm and the flexible touch screen panel may also include a phase difference compensating layer formed on the thin film substrate.

The phase difference compensating layer may include a positive C plate, and have the same thickness as that of the thin film substrate.

The phase difference compensating layer may have a thickness from about 0.005 mm to about 0.05 mm.

The flexible touch screen panel may also include a polarizer attached to the phase difference compensating layer and a window substrate attached to the polarizer, where the window substrate may include at least one of polymethyl methacrylate (PMMA), acryl, and polyester (PET).

Each of the plurality of sensing patterns may include first sensing cells connected to each other in a first direction, first connecting lines for connecting adjacent first sensing cells to each other, second sensing cells connected to each other in a second direction and second connecting lines for connecting adjacent second sensing cells to each other.

The panel may also include an insulating layer disposed at intersections between the first connecting lines and the second connecting lines.

The panel may also include a black matrix formed on the non-active area.

According to certain embodiments, a very thin film touch screen panel in which a phase difference may be compensated is attached between an upper side and a polarizer of the display device so that only minimized thickness may be increased and low reflection and high end image quality may be realized.

### BRIEF DESCRIPTION OF THE DRAWINGS

The accompanying drawings, together with the specification, illustrate certain embodiments, and, together with the description, serve to explain the principles of the present invention.

FIG. 1 is a plan view schematically illustrating an embodiment of a touch screen panel;

FIG. 2 is an enlarged view illustrating an example of sensing patterns by the embodiment of a touch screen panel of FIG. 1;

FIG. 3 is a sectional view of an area I-I′ of the embodiment of a touch screen panel of FIG. 1; and

FIG. 4 is a graph illustrating characteristics of a phase difference compensating layer.

### DETAILED DESCRIPTION OF CERTAIN INVENTIVE EMBODIMENTS

In the following detailed description, only certain embodiments of the present invention have been shown and described, simply by way of illustration. As those skilled in the art would realize, the described embodiments may be modified in various ways, without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals generally refer to like elements. Some elements may be shown with exaggerated thickness in the drawings, for illustration purposes.

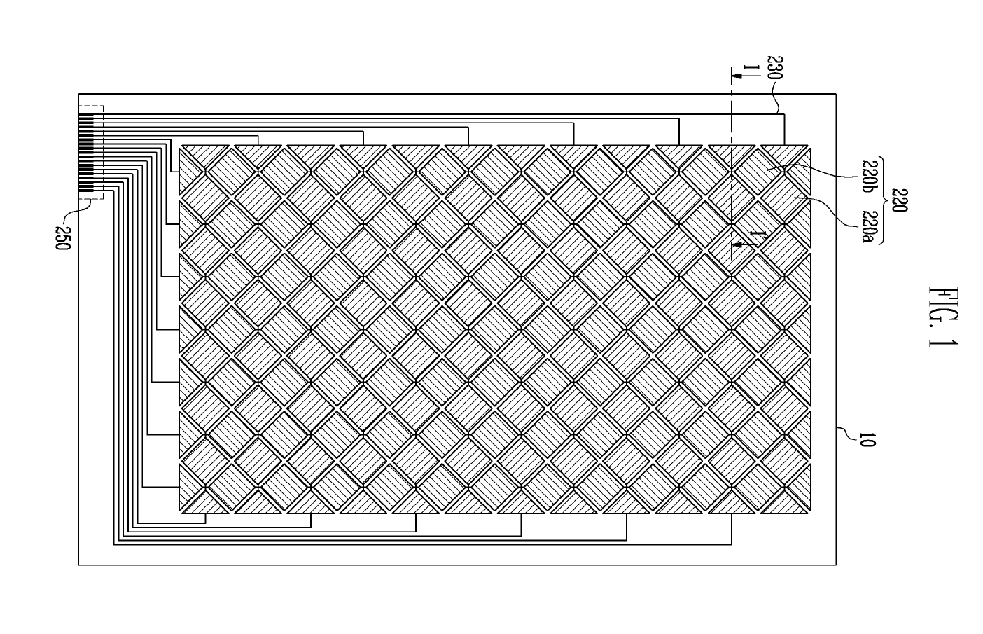

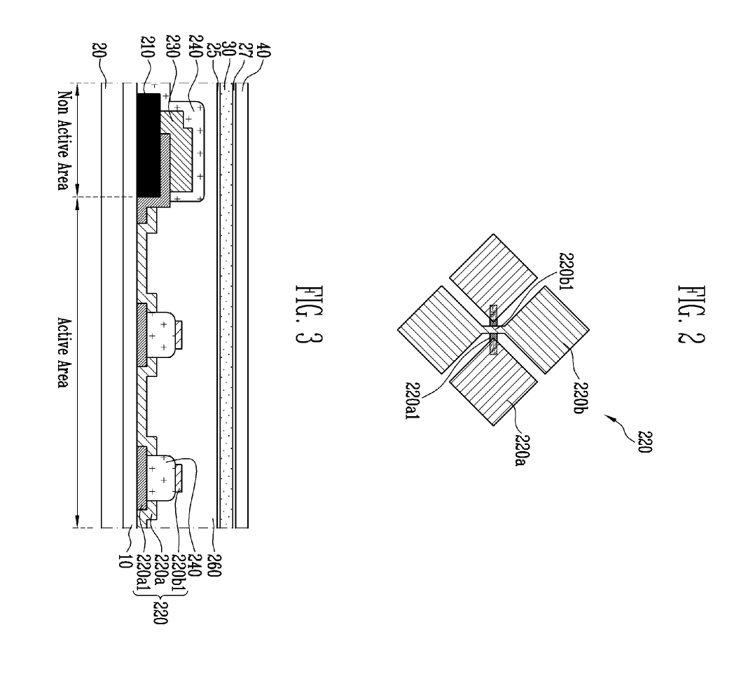

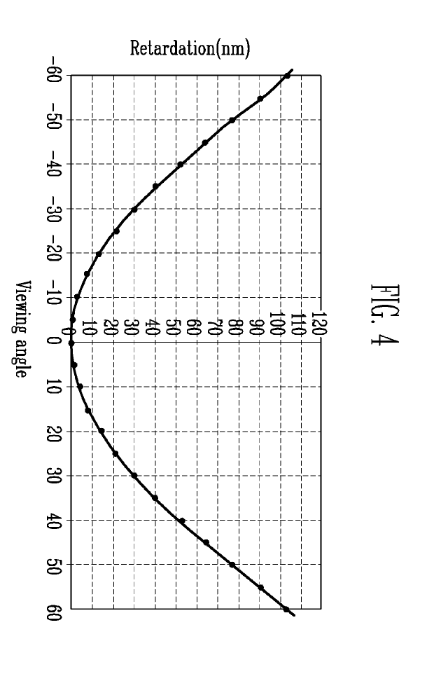

FIG. 1 is a plan view schematically illustrating an embodiment of a touch screen panel. FIG. 2 is an enlarged view illustrating an example of sensing patterns of the embodiment of a touch screen panel of FIG. 1. FIG. 3 is a sectional view of an area I-I′ of FIG. 1.

Referring to FIGS. 1 to 3, an embodiment of a touch screen panel includes a thin film substrate 10 having a flexibility characteristic, sensing patterns 220 formed on a first side of the thin film substrate 10, and sensing lines 230 for connecting the sensing patterns 220 to an external driving circuit (not shown) through a pad unit 250.

The thin film substrate 10 is made of transparent material with high heat resistance and high chemical resistance, such as for example, polyimide (PI).

In some embodiments the thin film substrate 10 may be about 0.005 mm to about 0.05 mm thick. In some embodiments, the thin film substrate may be about 0.01 mm (10 μm).

The sensing patterns 220, as illustrated in FIG. 2, include a plurality of first sensing cells 220a connected to each other at every row line along the row direction, a plurality of first connecting lines 220a1 for connecting the first sensing cells 220a to each other in the row direction, a plurality of second sensing cells 220b connected to each other at every column line along the column direction, and a plurality of second connecting lines 220b1 for connecting the second sensing cells 220b to each other in the column direction.

Although some of the sensing patterns are illustrated in FIG. 2 for illustrative purposes, embodiments of the touch screen panel have a structure in which the sensing patterns as illustrated in FIG. 2 are repeatedly arranged.

The first sensing cells 220a and the second sensing cells 220b are alternately arranged without overlapping with each other, and the first connecting lines 220a1 and the second connecting lines 220b1 are crossed with each other. An insulating layer (not shown) is disposed between the first connecting lines 220a1 and the second connecting lines 220b1 for guaranteeing the stability.

The first sensing cells 220a and the second sensing cells 220b may be made of a transparent conductive material, such as for example indium-tin-oxide (hereinafter, referred to as ‘ITO’) to be integrated with or to be separated from the first connecting lines 220a1 and the second connecting lines 220b1 for electrical connection.

In some embodiments, the second sensing cells 220b may be patterned in the column direction to be integrated with the second connecting lines 220b1, and the first sensing cells 220a may be patterned to have independent patterns between the second sensing cells 220b and to be connected to each other in the row direction by the first connecting lines 220a1 that are positioned upper or lower the first sensing cells 220a.

In such embodiments, the first connecting lines 220a1 may be electrically connected to the first sensing cells 220a by a direct contact with the first sensing cells 220a at the upper or lower sides of the first sensing cells 220a, or through contact holes.

The first connecting lines 220a1 may be made of a transparent conductive material such as ITO, or an opaque low resistance metal, while widths thereof may be adjusted to prevent the patterns from being visualized.

The sensing lines 230 as illustrated in FIG. 1 are electrically connected to the first and second sensing cells 220a and 220b by every row unit and column unit. The first and second sensing cells 220a and 220b are also connected by the sensing lines 230 to an external driving circuit (not shown) such as a position detecting circuit, through the pad unit 250.

The sensing lines 230 are disposed in a non-active area (outside an active area on which an image is displayed) and may be made of various materials, such as for example, low resistance metals such as molybdenum (Mo), silver (Ag), Titanium (Ti), copper (Cu), and aluminum (Al), molybdenum/aluminum/molybdenum (Mo/Al/Mo), or the transparent conductive material used in making the sensing patterns 220.

In some embodiments, the touch screen panel is a capacitive touch screen panel. When a touch tool such as a finger, a stylus pen, and the like, touches the touch screen panel, change of capacitance at the touch position is transmitted from the sensing patterns 220 to the driving circuit (not shown) via the sensing lines 230 and the pad unit 250. The change of capacitance is converted into an electric signal by an X- and a Y-input processing circuit (not shown) and the touch position is detected.

FIG. 3 is a sectional view of a part of the non-active and active areas of the touch screen panel formed on the first side of the thin film substrate 10.

FIG. 3 illustrates a display device 20 attached on a second side of the thin film substrate 10. The display device 20 may be a flexible display device such as an organic light emitting display device.

Referring to FIG. 3, the sensing patterns 220 formed on the active area of the thin film substrate 10 include first sensing cells 220a connected to each other at every row line in the first direction, first connecting lines 220a1 for connecting the first sensing cells 220a to each other in the row direction, second sensing cells 220b connected to each other at every column in the column direction, and second connecting lines 220b1 for connecting the second sensing cells 220b to each other in the column direction, and insulating layers 240 are disposed at intersections between the first connecting lines 220a1 and the second connecting lines 220b1.

On the non-active area outside the active area, a black matrix 210 and sensing lines 230 overlapped with the black matrix 210 and electrically connected to the sensing patterns 220 are formed.

The black matrix 210 prevents the patterns such as the sensing lines 230 formed on the non-active area from being visualized, and forms edges of a display area.

In some embodiments, the thin film substrate 10 is made of polyimide (PI) with the highest heat resistance among flexible polymers.

The touch screen panel may be implemented to be attached to an upper side of the display device 20, and in order to improve see-through sensing patterns 220 and reflection property, may further include a polarizer 30 provided on the upper surface of the touch screen panel.

In such embodiments, the touch screen panel is positioned between the display device 20 and the polarizer 30 so that the sensing patterns 230 may be prevented from being seen through, and that reflectance may be minimized.

In order to improve mechanical strength, a window substrate 40 is further provided on the upper surface of the polarizer 30.

Since the display device 20 and the touch screen panel are flexible, the window substrate 40 may be also made of a flexible material.

The window substrate 40 may be made of polymethyl methacrylate (PMMA), acryl, and polyester (PET), and may be about 0.7 mm thick.

The attachment of the polarizer 30 and the window substrate 40 to the first surface of the thin film substrate 10 on which the sensing patterns and the like are formed may be implemented by first and second adhesive layers 25 and 27 disposed therebetween. The first and second adhesive layers 25 and 27 may be made of transparent adhesive with high light transmission, such as for example super view resin (SVR) or optical cleared adhesive (OCA).

In embodiments of the touch screen panel, a polyimide thin film substrate 10 with flexibility is used as a base substrate. However, polyimide has drawbacks such that phase difference in the thickness direction (Z-axis) Rth is negative (−), similar to a negative C plate.

When the thickness of the polyimide thin film substrate 10 is about 0.01 mm (10 μm), a phase difference of about −1, 100 nm occurs in the thickness direction.

Therefore, as illustrated in FIG. 3, a phase difference compensating layer 260 is further formed on the first surface of the thin film substrate 10 on which the sensing patterns are formed. The phase difference compensating layer 260 is formed between the first surface of the thin film substrate 10 on which the sensing patterns are formed, and the polarizer 30.

In addition, the phase difference compensating layer 260, in order to compensate Rth generated from the PI thin film substrate 10, may be made of a positive C plate with property opposite to the PI thin film substrate 10. Properties of the positive C plate are illustrated in the graph of FIG. 4. FIG. 4 is a graph illustrating characteristics of a phase difference compensating layer of FIG. 3.

Referring to FIG. 4, since Rth, a phase difference in the thickness direction (Z-axis) is positive (+), the phase difference compensating layer 260 including the positive C plate may compensate the phase difference of the PI thin film substrate 10.

The positive C plate may have the same thickness as that of the thin film substrate 10.

The phase difference compensating layer 260 including the positive C plate may be formed on the first surface of the thin film substrate on which the sensing patterns are formed in various ways.

In various embodiments, the phase difference compensating layer 260 may be formed in UV curing after performing roll to roll wet coating, path spin, slit coating, or other coating methods.

While the present invention has been described in connection with certain embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A flexible touch screen panel comprising:
a thin film substrate comprising an active area and a non-active area, the non-active-area positioned outside the active area;
a plurality of sensing patterns formed on the active area; and
sensing lines formed on the non-active area and connected to the sensing patterns;
wherein the thin film substrate is made of polyimide.

2. The flexible touch screen panel of claim 1, wherein the thin film substrate has a thickness from about 0.005 mm to about 0.05 mm.

3. The flexible touch screen panel of claim 1, further comprising a phase difference compensating layer formed on the thin film substrate.

4. The flexible touch screen panel of claim 3, wherein the phase difference compensating layer comprises a positive C plate.

5. The flexible touch screen panel of claim 3, wherein the phase difference compensating layer has the same thickness as that of the thin film substrate.

6. The flexible touch screen panel of claim 3, further comprising:
a polarizer attached to the phase difference compensating layer; and
a window substrate attached to the polarizer.

7. The flexible touch screen panel of claim 6, wherein the window substrate comprises at least one of polymethyl methacrylate (PMMA), acryl, and polyester (PET).

8. The flexible touch screen panel of claim 1, wherein each of the plurality of sensing patterns comprises:
first sensing cells connected to each other in a first direction;
first connecting lines for connecting adjacent first sensing cells to each other;
second sensing cells connected to each other in a second direction perpendicular to the first direction; and
second connecting lines for connecting adjacent second sensing cells to each other.

9. The flexible touch screen panel of claim 8, further comprising an insulating layer disposed at intersections between the first connecting lines and the second connecting lines.

10. The flexible touch screen panel of claim 1, further comprising a black matrix formed on the non-active area.

11. The flexible touch screen panel of claim 3, wherein the phase difference compensating layer has a thickness from about 0.005 mm to about 0.05 mm.
